(19) United States
(12) Patent Application Publication
(10) Pub. No.: US 2019/0213842 A1
(43) Pub. Date: Jul. 11, 2019

(54) Systems and Methods Including Playing Surfaces for Card Games

(71) Applicant: Samuel Irby, Garland, TX (US)

(72) Inventor: Samuel Irby, Garland, TX (US)

(21) Appl. No.: 16/200,258

(22) Filed: Nov. 26, 2018

Related U.S. Application Data
(60) Provisional application No. 62/614,196, filed on Jan. 5, 2018.

(51) Int. Cl. G07F 17/32

(52) U.S. Cl. CPC G07F 17/3293; G07F 17/3276; G07F 17/322

(57) ABSTRACT

This disclosure includes physical and virtual playing surfaces for card games, ones of which have a set of card positions and one or more player positions, each including: (1) a first chip position corresponding to a combination of two or more of the card positions; and (2) second chip positions, each corresponding to a respective one of the card positions, as well as systems and methods for playing card games using such playing surfaces.

### CROSS-REFERENCE TO RELATED APPLICATIONS

This application claims priority to U.S. Provisional Application No. 62/614,196, filed on Jan. 5, 2018, the entire content of which is specifically incorporated by reference herein without disclaimer.

### BACKGROUND

### 1. Field of Invention

The present invention relates generally to card games, and more specifically, to physical and virtual (i.e., graphically-displayed) playing surfaces for card games, ones of which include a set of card positions and one or more player positions, each including: (1) a first chip position corresponding to a combination of two or more of the card positions; and (2) second chip positions, each corresponding to a respective one of the card positions, as well as systems and methods for playing card games using such playing surfaces.

### 2. Description of Related Art

Card games, with or without gambling, offer enjoyment to players. Examples of card games include variants of poker, which is a class of games that involves players collecting hands of cards with the goal of having the hand with the highest ranking. Variants of poker include those in which player hands consist of three, five, or seven cards, those in which player hands share community cards, and those in which players are permitted to discard and draw cards.

### SUMMARY

Players of card games often enjoy new games, particularly ones that are quickly learnable and playable. Some embodiments of the present disclosure provide a quickly learnable and playable card game in which a predetermined number of playing cards are dealt onto a dealer position of playing surface, and each of one or more players indicates which of the dealt cards is expected by the player to have the highest value by selecting one or more of a plurality of chip positions provided to the player on the playing surface, the chip positions including: (1) a first chip position corresponding to a combination of two or more of the dealt cards; and (2) second chip positions, each corresponding to a respective one of the dealt cards, where—in some instances, depending on the ranking of a poker hand defined by the dealt cards—players whose indications are correct are winning players.

For some players, poker variants are particularly enjoyable. In poker variants where gambling is involved, wagers are typically placed, and thus money changes hands, between players. When such poker variants are offered in a casino, the casino usually does not accept wagers from the players and instead earns money by charging the players a fee for playing. Thus, casinos may earn less money from such poker variants than from games in which players bet against the casino. Some embodiments of the present disclosure include aspects of such poker variants, thereby attracting players who enjoy such poker variants, while allowing—in some instances, requiring—players to place wagers against the house, thereby increasing money earned by the house. Illustrative of such aspects, in some embodiments, players can place wagers against one another by, for example, each of those players placing: (1) a marker onto one of their chip positions that corresponds to the dealt card(s) that the player expects have the highest value; and (2) one or more chips onto a side bet position of the playing surface. In some embodiments, when players have placed wagers against one another, the dealt cards can be revealed one at a time, and, after each such revealing, those players can be provided with an opportunity to bet, check, or fold. In some embodiments, winning players can be paid according to the poker hand defined by the dealt cards.

Some embodiments of the present systems for playing a card game with one or more decks of playing cards include: a playing surface comprising a dealer position having card positions demarcated on the playing surface, player positions disposed around the dealer position, each of the player positions including chip positions demarcated on the playing surface, the chip positions having: (1) a first chip position corresponding to a combination of two or more of the card positions; and (2) second chip positions, each corresponding to a respective one of the card positions. In some systems, the playing surface comprises a side bet position that is disposed between the dealer position and at least one of the player positions and demarcated on the playing surface. Some systems comprise chips, each configured to be received on one of the chip positions, and markers, each configured to be received on one of the chip positions.

In some systems, each of the card positions is labeled on the playing surface with a respective symbol, and each of the second chip positions is labeled on the playing surface with the same symbol as is its respective one of the card positions. In some systems, the card positions consist of five card positions.

In some systems, each of the card positions is labeled on the playing surface with a respective symbol, and each of the second chip positions is labeled on the playing surface with the same symbol as is its respective one of the card positions.

Some embodiments of the present methods for playing a card game with one or more decks of playing cards comprise: dealing a predetermined number of playing cards, each having a value, onto a dealer position of a playing surface, the playing surface including one or more player positions, each including chip positions demarcated on the playing surface, the chip positions having: (1) a first chip position corresponding to a combination of two or more of the dealt cards; and (2) second chip positions, each corresponding to a respective one of the dealt cards, and receiving, from each of one or more players, each associated with a respective one of the player position(s), one or more primary selections indicative of which of the dealt cards is expected by the player to have the highest value, each of the primary selection(s) including a selection from the group consisting of: the first and second chip positions. In some methods, for each of the player(s), each of the primary selection(s) is received by receiving one or more chips from the player onto the selected one of the chip positions.

In some methods, the dealer position includes card positions demarcated on the playing surface, and dealing the playing cards is performed such that each of the dealt cards is positioned on a respective one of the card positions. In some methods, the predetermined number of playing cards consists of five playing cards.

Some methods comprise: (1) if the dealt cards define a poker hand having a ranking of one pair or higher: (a) determining the highest value of the dealt cards; (b) if two or more of the dealt cards each have the highest value, identifying one(s) of the primary selection(s) that select the first chip position as winning primary selection(s); and (c) if a single one of the dealt cards has the highest value, identifying one(s) of the primary selection(s) that select the second chip position corresponding to the single card as winning primary selection(s); and (2) if the dealt cards do not define a poker hand having a ranking of one pair or higher, identifying a house as a winner.

Some methods comprise: (1) determining the highest value of the dealt cards; (2) if two or more of the dealt cards each have the highest value, identifying one(s) of the primary selection(s) that select the first chip position as winning primary selection(s); and (3) if a single one of the dealt cards has the highest value, identifying one(s) of the primary selection(s) that select the second chip position corresponding to the single card as winning primary selection(s).

In some methods, the player(s) comprise two or more players, and the method comprises receiving, from each of at least two participating ones of the players, a secondary selection indicative of which of the dealt cards is expected by the player to have the highest value, the secondary selection including a selection from the group consisting of: the first and second chip positions. In some methods, for each of the participating players, the secondary selection is received by receiving a marker from the player onto the selected one of the chip positions, and receiving one or more chips from the player onto a side bet position of the playing surface that is disposed between the dealer position and at least one of the player positions.

Some methods comprise: (1) determining the highest value of the dealt cards; (2) if two or more of the dealt cards each have the highest value: (a) if at least one of the secondary selections selects the first chip position, identifying those secondary selection(s) as winning secondary selection(s); and (b) if none of the secondary selections select the first chip position, identifying one(s) of the secondary selections that, of the second chip position(s) selected by the secondary selections, select the second chip position(s) that correspond to the dealt card(s) having the highest value as winning secondary selection(s); and (3) if a single one of the dealt cards has the highest value, identifying one(s) of the secondary selections that, of the second chip position(s) selected by the secondary selections, select the second chip position(s) that correspond to the dealt card(s) having the highest value as winning secondary selection(s).

Some embodiments of the present systems for playing a card game comprise: a processor configured to cause a display in communication with the processor to depict a playing surface comprising a dealer position including a predetermined number of playing cards and one or more player positions, each including chip positions demarcated on the playing surface, the chip positions having: (1) a first chip position corresponding to a combination of two or more of the predetermined number of playing cards; and (2) second chip positions, each corresponding to a respective one of the predetermined number of playing cards, and receive, from each of one or more players, each associated with a respective one of the player position(s), one or more primary selections indicative of which of the predetermined number of playing cards is expected by the player to have the highest value, each of the primary selection(s) including a selection from the group consisting of: the first and second chip positions. In some systems, the predetermined number of playing cards consists of five playing cards.

In some systems, the processor is configured to: (1) if the predetermined number of playing cards define a poker hand having a ranking of one pair or higher: (a) determine the highest value of the predetermined number of playing cards; (b) if two or more of the predetermined number of playing cards each have the highest value, identify one(s) of the primary selection(s) that select the first chip position as winning primary selection(s); and (c) if a single one of the predetermined number of playing cards has the highest value, identify one(s) of the primary selection(s) that select the second chip position corresponding to the single card as winning primary selection(s); and (2) if the predetermined number of playing cards do not define a poker hand having a ranking of one pair or higher, identify a house as a winner.

In some systems, the processor is configured to: (1) determine the highest value of the predetermined number of playing cards; (2) if two or more of the predetermined number of playing cards each have the highest value, identify one(s) of the primary selection(s) that select the first chip position as winning primary selection(s); and (3) if a single one of the predetermined number of playing cards has the highest value, identify one(s) of the primary selection(s) that select the second chip position corresponding to the single card as winning primary selection(s).

In some systems, the processor is configured to receive, from each of at least two participating ones of the player(s), a secondary selection indicative of which of the predetermined number of playing cards is expected by the player to have the highest value, the secondary selection including a selection from the group consisting of: the first and second chip positions. In some systems, the processor is configured to: (1) determine the highest value of the predetermined number of playing cards; (2) if two or more of the predetermined number of playing cards each have the highest value: (a) if at least one of the secondary selections selects the first chip position, identify those secondary selection(s) as winning secondary selection(s); and (b) if none of the secondary selections select the first chip position, identify one(s) of the secondary selections that, of the second chip position(s) selected by the secondary selections, select the second chip position(s) that correspond to the predetermined number of playing card(s) having the highest value as winning secondary selection(s); and (3) if a single one of the predetermined number of playing cards has the highest value, identify one(s) of the secondary selections that, of the second chip position(s) selected by the secondary selections, select the second chip position(s) that correspond to the predetermined number of playing card(s) having the highest value as winning secondary selection(s).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIGS. 1 and 2 are schematic top views of first and second embodiments, respectively, of the present playing surfaces, each of which is suitable for use in some of the present systems and methods for playing card games.

FIGS. 3A-3C depict game pieces—a chip, a marker, and a button, respectively—each of which is suitable for use in some of the present systems and methods for playing card games.

FIG. 4 depicts some of the present methods for playing card games, the methods including receiving, from each of one or more players, one or more selections indicative of which of a predetermined number of playing cards is expected by the player to have the highest value, and determining whether each of the selection(s) is a winning selection.

FIGS. 5, 6A, and 6B depict methods for determining whether each of the selection(s) is a winning selection.

FIGS. 7 and 8 are schematic views of first and second embodiments, respectively, of the present systems for playing card games.

### DETAILED DESCRIPTION

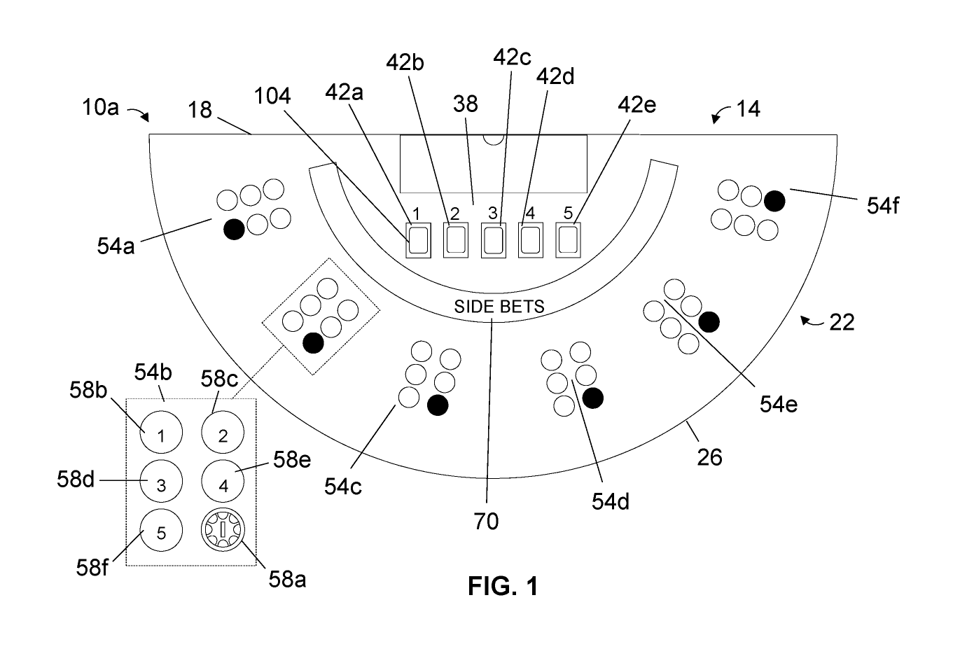

FIG. 1 depicts a first embodiment 10a of the present playing surfaces. Playing surface 10a, as with other playing surfaces of the present disclosure, can be a physical playing surface. For example, playing surface 10a can be positioned on the top of a table around which a dealer and one or more players can sit or stand while card games are played on the playing surface. Such positioning can be fixed or removable; for example, the playing surface can be defined by the top of the table, or the playing surface can be defined by a cover that can be removably positioned on the top of the table. When so positioned, at least a majority of playing surface 10a can be flat to, for example, facilitate positioning of playing cards, game pieces (e.g., one or more of chip 82, marker 86, and/or the like, described below), and the like on the playing surface. In its physical embodiments, playing surface 10a can be defined by any suitable material, such as, for example, felt, wood, metal, plastic (e.g., vinyl), and/or the like. Nevertheless, playing surface 10a—as well as other playing surfaces of the present disclosure—can be a virtual playing surface, or one that is caused by one or more processors to be displayed on one or more displays associated with one or more players while a game is played using the playing surface (e.g., processor(s) 198 and/or 214 and display(s) 194, described below).

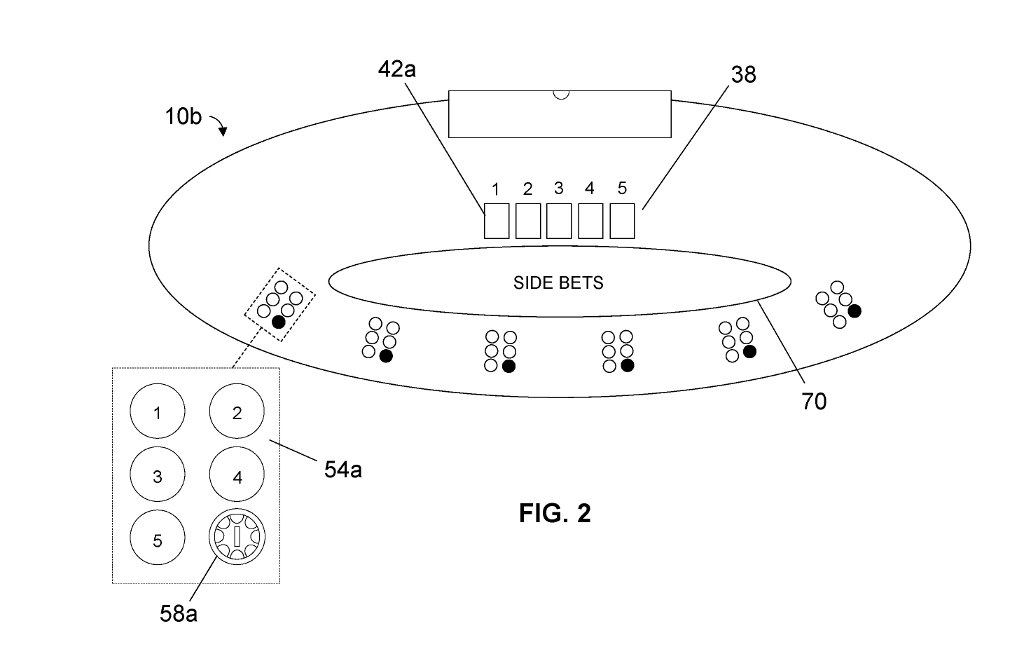

When viewed from above or displayed on a display, playing surface 10a can have a semi-ovular shape. To illustrate, playing surface 10a can include a first side 14 that terminates at a straight edge 18 and a second side 22 that is opposite to the first side and terminates at an arcuate edge 26. At least one end of arcuate edge 26 can connect with straight edge 18 via a sharp or rounded corner. Such a shape can facilitate playing of games on playing surface 10a; for example, players positioned behind and along arcuate edge 26 can be substantially equidistant from a dealer (when the dealer is centrally-positioned behind straight edge 18) and/or playing cards placed on the playing surface by the dealer. Other embodiments of the present playing surfaces can have any suitable shape, such as, for example, one that is triangular, square, rectangular, otherwise polygonal, circular, semi-circular, ovular, semi-ovular, otherwise rounded, or the like when viewed from above or displayed on a display. For example, FIG. 2 depicts a second embodiment 10b of the present playing surfaces that, though otherwise similar to playing surface 10a, has a shape that is ovular.

Playing surface 10a can include a dealer position 38, which can be characterized as a portion of the playing surface that, when games are played using the playing surface, is under the control of a dealer or a house such that, for example, players are not permitted to, or are prevented from, placing objects on, removing objects from, or otherwise unilaterally altering the state of the dealer position. In physical embodiments of playing surface 10a, structure(s) that can be used by a dealer to facilitate playing of games using the playing surface, such as, for example, a chip holder, a card shoe, and/or the like, can be disposed on and/or be defined by dealer position 38 and/or can be coupled to a table on which the playing surface is disposed and behind the dealer position.

Dealer position 38 can include a plurality of card positions, or portions of the dealer position to which playing cards can be dealt. As shown, dealer position 38 includes five such card positions, 42a-42e. The card positions can be positioned in a row; for example, a straight line that extends through one of the card positions can extend through each other of the card positions. Other embodiments of the present playing surfaces can include any suitable number of card positions (e.g., 2, 3, 4, 5, 6, 7, or more card positions), and such card positions can be positioned relative to one another in any suitable fashion (e.g., in a row, along an arc, oval, circle, triangle, square, rectangle, or the like).

Each of card positions 42a-42e can be demarcated on the playing surface. A position (e.g., any one of the positions described herein) of a playing surface (e.g., 10a) can be “demarcated” on the playing surface in any fashion that visibly distinguishes that position from adjacent portions of the playing surface. For example, if the playing surface is a physical playing surface, the position can demarcated by a colorant (e.g., a pigment, dye, ink, and/or the like) having a color that is visually-distinguishable from that of portions of the playing surface adjacent to the position. Such a colorant can be disposed on the playing surface so that the colorant fills and/or forms a border around at least a portion of—up to and including all of—the position, labels the position with a symbol (e.g., one or more numbers, letters, words, and/or the like), and/or the like. In some instances, the position can be demarcated by one or more walls of the playing surface that surround at least a portion of—up to and including all of—the position, a recess of the playing surface within which the position lies, and/or the like. To illustrate, in physical embodiments of playing surface 10a, each of card positions 42a-42e can be demarcated on the playing surface via a colorant that is disposed on the playing surface such that the colorant defines a rectangular border surrounding the card position and labels the card position with a symbol—a number, in the depicted embodiment.

For further example, if the playing surface is a virtual playing surface, the position can be demarcated by displaying the position using a color that is visually-distinguishable from that used to display portions of the playing surface adjacent to the position, displaying a border around at least a portion of—up to and including all of—the position, labeling the position with a symbol, and/or the like. To illustrate, in virtual embodiments of playing surface 10a, each of card positions 42a-42e can be demarcated on the playing surface by displaying a rectangular border that surrounds the card position and labeling the card position with a symbol.

Playing surface 10a can include at least one player position, which can be characterized as a portion of the playing surface that, when games are played using the playing surface, is under the control of a player such that, for example, the player is permitted to place objects on, remove objects from, and, in at least some instances, unilaterally alter the state of the player position. As shown, playing surface 10a includes six such player positions, 54a-54f In order to mitigate differences in the distances between dealer position 38 and each of the player positions, the player positions can be disposed around the dealer position. To illustrate, in playing surface 10a, the player positions can disposed along an arc, and dealer position 38 can be at least partially disposed within an arc segment area of the arc. Other embodiments of the present playing surfaces can include any suitable number of player positions (e.g., 1, 2, 3, 4, 5, 6, 7, 8, or more player positions), and, in embodiments including two or more player positions, the player positions can be positioned relative to one another in any suitable fashion (e.g., in a row or along an arc, oval, circle, triangle, square, rectangle, or the like).

Each of player positions 54a-54f can include a plurality of chip positions, or portions of the player position to which the player can place game pieces. More particularly, in playing surface 10a, each of the player positions includes six chip positions, 58a-58f As shown, for each of the player positions, the chip positions can be disposed in two adjacent rows, each including three of the chip positions. Other embodiments of the present playing surfaces can include one or more player positions, each having any suitable number of chip positions (e.g., 2, 3, 4, 5, 6, 7, 8, 9, 10, or more chip positions), and such chip positions can be positioned relative to one another in any suitable fashion (e.g., in row(s), along an arc, oval, circle, triangle, square, rectangle, or the like).

In some playing surfaces (e.g., 10a), for each of one or more player positions (e.g., 54a-54f) of the playing surface, each of a plurality of chip positions (e.g., 58a-58f) of the player position can correspond to at least one of a plurality of card positions (e.g., 42a-42e) of the playing surface. For example, in such playing surfaces, for each of the player position(s), each of one or more of the chip positions can correspond to a respective one of the card positions, each of one or more of the chip positions can correspond to a combination of two or more of the card positions (whether to specific ones of the card positions or to two or more of any of the card positions), and/or the like. In this way, when games are played using the playing surface, a player associated with one of the player position(s) can select one or more of a plurality of cards, each occupying a respective one of the card positions, by selecting one(s) of the chip positions of the player position that correspond to card position(s) occupied by those card(s). To illustrate, for each of player positions 54a-54f of playing surface 10a, chip positions 58b-58f each correspond to a respective one of card positions 42a-42e, and chip position 58a corresponds to a combination of any two or more of the card positions.

For each of player positions 54a-54f, chip positions 58a-58f can each be demarcated—as described above—on the playing surface. To illustrate, in playing surface 10a, each of chip positions 58a-58f can be demarcated on the playing surface via a circular border that surrounds the chip position and a symbol that labels the chip position. In physical embodiments, the border and the label can be defined by a colorant disposed on the playing surface, and, in virtual embodiments, the border and the label can be displayed on the playing surface.

Card positions 42a-42e and chip positions 58a-58f can be demarcated on playing surface 10a in a way that indicates, for each of the chip positions, which of the card positions that the chip position corresponds to. For example, each of card positions 42a-42e can be labeled on the playing surface with a respective symbol, and each of chip positions 58b-58f can be labeled on the playing surface with the same symbol as is the one of the card positions that the chip position corresponds to. Two symbols can be considered the same symbol even if those symbols have a different size, color, and/or, if including number(s), letter(s), and/or word(s), font. To illustrate, card positions 42a-42e can be labeled with numbers 1-5, respectively, and chip positions 58b-58f can be labeled with numbers 1-5, respectively, and the numbers labeling the card positions can—but need not—have the same size, color, or font as the numbers labeling the chip positions. In other playing surfaces, correspondence between a chip position (e.g., any one of 58a-58f) and a card position (e.g., any one of 42a-42e) can be indicated by using a same symbol, color, border shape, and/or the like to demarcate the chip position and the card position on the playing surface.

For further example, chip position 58a, which corresponds to a combination of two or more of any of card positions 42a-42e, can be demarcated using a unique color, border shape (e.g., irrespective of size), symbol (e.g., in its number(s), letter(s), and/or word(s)), and/or the like from that used to demarcate any single one of the card positions. To illustrate, in playing surface 10a, chip position 58a can be demarcated with a symbol that includes a logo, such as, for example, a logo associated with the house.

Playing surface 10a can include a side bet position 70, or a portion of the playing surface to which players can place game pieces that is distinct from chip positions 58a-58f Side bet position 70 can be disposed between dealer position 38 and at least one of, up to and including each of, player positions 54a-54f. Such positioning can, when games are played using playing surface 10a, facilitate access to side bet position 70 by a dealer associated with dealer position 38 as well as players associated with player positions 54a-54f When playing games on playing surface 10a that involve gambling, side bet position 70 can distinguish wagers placed between players from wagers placed between a player and the house. For example, a wager (e.g., in the form of one or more of chip 82) can be placed by a player: (1) against the house by positioning the wager on one or more of chip positions 58a-58f; or (2) against another player by positioning the wager on side bet position 70. While playing surface 10a is depicted as including a single side bet position 70, other playing surfaces can include two or more side bet positions (e.g., 2, 3, 4, 5, 6, 7, 9, or more side bet positions); for example, in some such playing surfaces, each of the side bet positions can form part of a respective one of player positions (e.g., 54a-54f) of the playing surface.

Side bet position 70 can be demarcated—as described above—on the playing surface. To illustrate, side bet position 70 can be demarcated on playing surface 10a via a border that surrounds the side bet position and a symbol—“SIDE BETS”—that labels the side bet position. In physical embodiments, the border and the label can be defined by a colorant disposed on the playing surface, and, in virtual embodiments, the border and the label can be displayed on the playing surface.

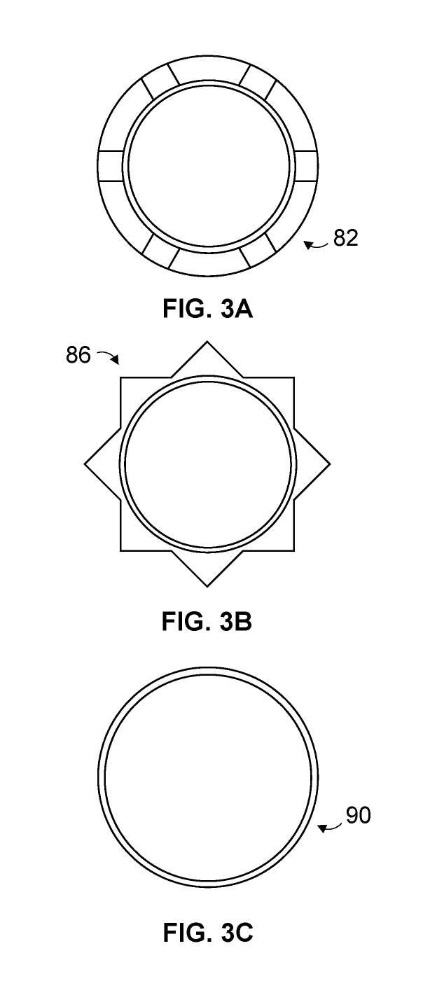

Referring now to FIGS. 3A-3C, shown are game pieces—a chip 82, a marker 86, and a button 90, respectively, each of which is suitable for use in some of the present systems and methods for playing card games. Such game pieces can be physical or virtual; virtual game pieces can be “placed” or “positioned” on a virtual playing surface by displaying those game pieces on the playing surface.

As described below, a player can position one or more of chip 82 on playing surface 10a to select, and, in some instances, place a wager on, which of a plurality of cards that are positioned on the playing surface is expected by the player to have the highest value. Chip 82 may be exchangeable for currency, and, if so, can have any suitable value, such as one that is greater than or equal to any one of, or between any two of: 1.00, 2.50, 5.00, 10.00, 25.00, or 100.00 United States Dollars (USD). Ones of chip 82 can have different values, and such chips can be visually-distinguishable from one another. For example, such chips can have differing colors and/or shapes. Chip 82 is shown as circular; however, chip 82—as with other game pieces, such as marker 86 and button 90—can have any suitable shape, such as one that is triangular, square, rectangular, otherwise polygonal, circular, ovular, or otherwise rounded. If used in a game that involves gambling, the shape of game pieces should conform with applicable gaming regulations.

Similarly to chip 82, marker 86 can be positioned on playing surface 10a by a player to select, and, in some instances, place a wager on, which of the cards that player expects to have the highest value (described below). More particularly, each player can be associated with a respective marker 86, and markers associated with different players can be visually-distinguishable from one another; for example, such markers can have differing colors and/or shapes. In this way, such markers can be used to distinguish one player's selection from another player's selection.

As described below, button 90 can be used to determine the order in which the cards are revealed. For example, button 90 can be associated with a single player—which may change over time—and card(s) selected by that player can be revealed before others of the cards are revealed. Button 90 and markers 86, each of which may not be exchangeable for currency, can be visually-distinguishable from chips 82; for example, the button and the markers can each have a color and/or a shape that differs from that of any of the chips.

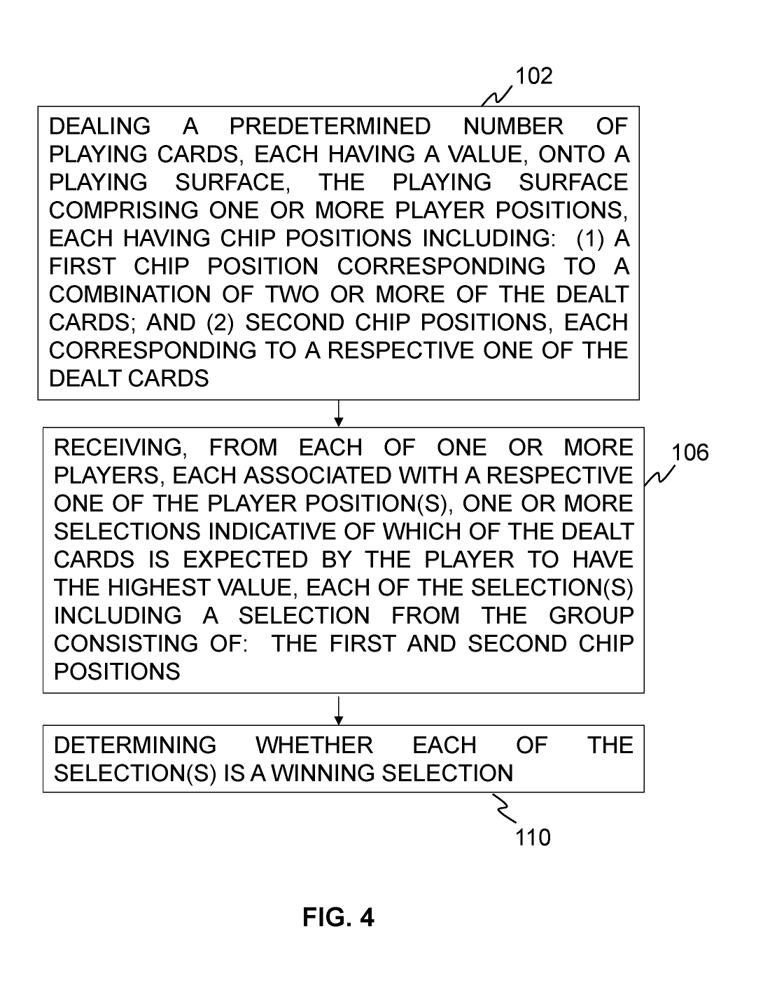

Referring now to FIG. 4, shown are some of the present methods for playing card games. In the following description, playing surface 10a is referenced to illustrate some of the present methods; however, playing surface 10a is not limiting on those methods, which can be performed using any suitable playing surface. Some methods include a step 102 of dealing a predetermined number of playing cards (e.g., 106, FIG. 1) onto a playing surface (e.g., 10a) (e.g., face down). In some instances, the predetermined number of playing cards (sometimes referred to as the “dealt cards”) can be placed on a dealer position (e.g., 38) of the playing surface, and more particularly, on respective ones of a plurality of card positions (e.g., 42a-42e) thereof. The dealt cards can comprise any suitable number of cards, such as, for example, 2, 3, 4, 5, 6, 7, or more cards, and the number of dealt cards may correspond to the number of the card positions of the playing surface. If the playing surface is a physical playing surface, the dealt cards can be physical cards that are placed onto the playing surface, and, if the playing surface is a virtual playing surface, the dealt cards can be virtual cards that are displayed on the playing surface.

The playing cards can include one or more decks of standard playing cards, where a deck of standard playing cards includes 52 playing cards divided amongst four suits, each including an ace, 2, 3, 4, 5, 6, 7, 8, 9, 10, jack, queen, and king. Each of the playing cards can be associated with a value; for example, TABLE 1 lists suitable values for playing cards in a standard deck of playing cards.

TABLE 1
Exemplary Values for Playing Cards
in a Standard Deck of Playing Cards

| Playing Card | Value |
|---|---|
| 2 | 1 |
| 3 | 2 |
| 4 | 3 |
| 5 | 4 |
| 6 | 5 |
| 7 | 6 |
| 8 | 7 |
| 9 | 8 |
| 10 | 9 |
| Jack | 10 |
| Queen | 11 |
| King | 12 |
| Ace | 13 |

Such playing cards and values are provided by way of illustration—other values can be associated with such playing cards (e.g., aces can have a value of 1, and the value of all cards other than aces can be increased by 1), and other types of playing cards can be used, provided that each of the playing cards is associated with a value, and two or more of the playing cards have values that differ.

Some methods comprise a step 106 of receiving, from each of one or more players, one or more selections indicative of which of the dealt cards is expected by the player to have the highest value. Such selection(s) from a player can be received in any suitable fashion. To illustrate, the player can be associated with a respective one of one or more player positions (e.g., 54a-54f) of the playing surface. The player position can include a plurality of chip positions (e.g., 58a-58f), each of which can correspond to one or more of the dealt cards, in some instances, by corresponding to one(s) of the card positions on which those dealt card(s) are placed. Thus, the selection(s) from the player can be received at least by receiving, from the player, selection(s) of one(s)—up to and including each—of the chip positions, which can be made by the player placing one or more game pieces (or causing one or more game pieces to be displayed) on those chip position(s).

In the illustrated methods, each of the selection(s) from each of the player(s) is either: (1) one that indicates a combination of any two or more of the dealt cards; or (2) one that indicates a specific one of the dealt cards. Consistently, for each of the player position(s), the chip positions include one chip position (e.g., 58a)—a “first chip position”—that corresponds to a combination of any two or more of the dealt cards and a plurality of other chip positions (e.g., 58b-58f)—“second chip positions”—each corresponding to a respective one of the dealt cards. In some methods, a player can make other selection(s), such as, for example, one that indicates a combination of two or more specific ones of dealt cards, and such methods can use playing surfaces having chip positions associated with such other selection(s). And in some instances, to make a secondary selection indicative of one or more of the dealt cards, a player must also make a primary selection indicative of those same dealt card(s).

For each of the player(s), the selection(s) can include those that are played against the house, referred to as “primary selection(s),” and those that are played against other(s) of the player(s), referred to as “secondary selection(s).” Primary and secondary selections can be distinguished by how they are made. For example, a player can make a primary selection at least by placing one or more of a first type of game piece on one of the chip positions associated with the player, and the player can make a secondary selection at least by placing one or more of a second type of game piece that is distinct from the first type of game piece on one of the chip positions. To illustrate, the first type of game piece can be a chip (e.g., 82), and the second type of game piece can be marker (e.g., 86). When gambling is involved, a wager accompanying a primary selection of a player can be placed on that player's player position; for example, the wager, in the form of one or more chips, can be placed on, and can be used to select, the chip position of the primary selection. A wager accompanying a secondary selection can be placed on a side bet position (e.g., 70) of the playing surface. In some instances, each player is required to make at least one primary selection and making a secondary selection is optional.

In processor-implemented methods, at step 106, one or more processors (e.g., 198 and/or 214) can receive input from each player indicative of that player's selection(s). Such input can be received via a user-input device (e.g., 190) associated with the player. The processor(s) can then cause display(s) (e.g., 194) to display game piece(s) on the playing surface corresponding to the player's selection(s) (e.g., game piece(s) on one(s) of that player's chip positions, game piece(s) on the side bet position, and/or the like).

Some methods comprise a step 110 of determining, for each of the player(s), whether the selection(s) of the player are winning selection(s). Steps for determining whether a selection is a winning selection can differ depending on whether the selection is a primary selection or a secondary selection.

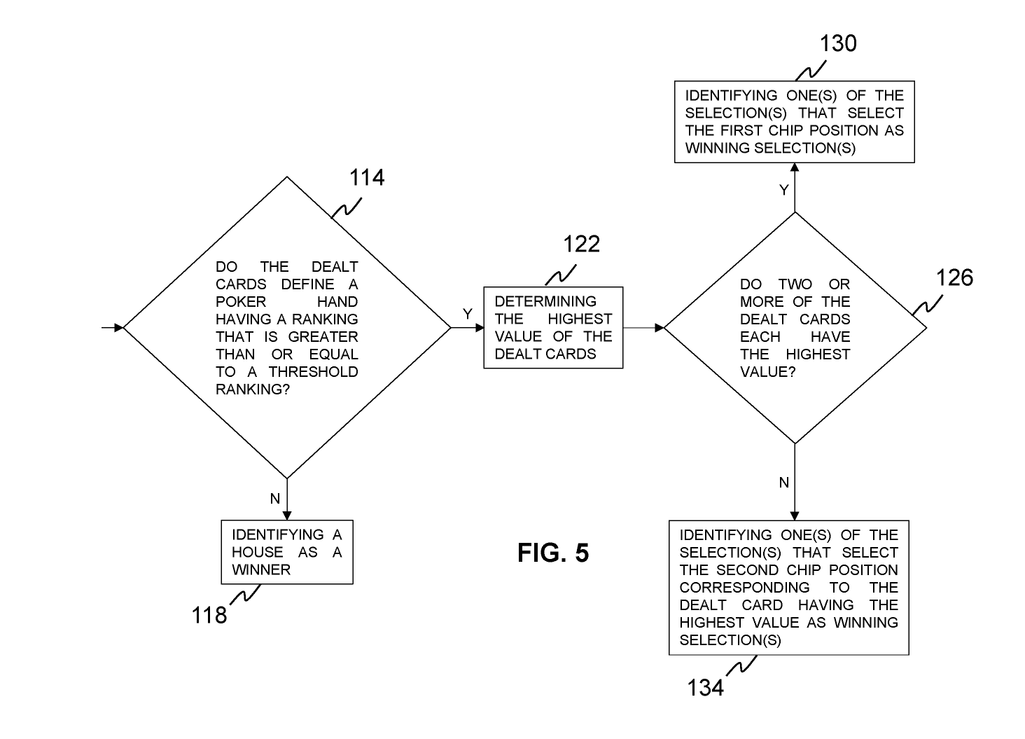

Referring now to FIG. 5, shown is a method that can be used to determine whether each of the primary selection(s) is a winning selection. To begin, the dealt cards can be revealed. In some instances, at step 114, a ranking of a hand defined by the dealt cards can be determined and compared to a threshold ranking, and, if the ranking of the hand is below the threshold ranking, none of the primary selection(s) are identified as winning selections. In processor-implemented methods, step 114 can include locating, with one or more processors (e.g., 198 and/or 214), the hand of dealt cards in a table that includes hands and associated rankings, and comparing the ranking associated with the hand of dealt cards to a threshold ranking.

If the playing cards include deck(s) of standard playing cards, the ranking of the hand and the threshold ranking can be poker hand rankings, exemplary ones of which are included in TABLE 2.

TABLE 2
Exemplary List of Poker Hands from
Lowest Ranking to Highest Ranking
Poker Hand

High Card
One Pair
Two Pair
Three of a Kind
Straight
Flush
Full House
Four of a Kind
Straight Flush
Royal Flush
Five of a Kind

Using TABLE 2 to illustrate, if the dealt cards define a high card hand and the threshold ranking is a one pair hand, none of the primary selection(s) are identified as winning selections. Of course, poker hands other than those listed in TABLE 2 can be ranked, the order in which poker hands are ranked can be varied, and/or the like. Further, any combinations of the playing cards can be ranked relative to one another—such combinations need not be poker hands (e.g., the playing cards may not include deck(s) of standard playing cards).

If the ranking of the hand is below the threshold ranking, at step 118, the house can be identified as a winner. At this step, any wager(s) associated with primary selection(s) of the player(s) can be won by the house, or, optionally, in certain circumstance(s), be returned to their respective player(s). Such a circumstance can be one in which the dealt cards define one of one or more specified hands; to illustrate, when the playing cards include deck(s) of standard playing cards, a specified hand can be a soft flush—one consisting of diamonds and hearts or spades and clubs.

If the ranking of the hand is above the threshold ranking—or if step 114 is omitted at step 122, the highest value of the dealt cards can be determined. Using the values in TABLE 1 to illustrate: (1) if the dealt cards are an 8, a 6, a 10, a king, and an ace, the highest value of the dealt cards is that of the ace-13; and (2) if the dealt cards are a 2, a 6, a jack, a jack, and a 7, the highest value of the dealt cards is that of the jacks-10. In some methods, at step 126, the number of the dealt cards that each have the highest value can be determined. To illustrate, in hand (1), a single one of the dealt cards—the ace—has the highest value, and, in hand (2), two of the dealt cards—the jacks—each have the highest value. In processor-implemented methods, such steps can be performed using one or more processors (e.g., 198 and/or 214) to compare the values of the dealt cards.

In the depicted methods, if two or more of the dealt cards each have the highest value, one(s) of the primary selection(s) that indicate a combination of any two or more of the dealt cards (e.g., by selecting a first chip position) can be identified as winning selection(s) at step 130. On the other hand, if a single one of the dealt cards has the highest value, one(s) of the primary selection(s) that indicate that card (e.g., by selecting a second chip position that corresponds to that card) can be identified as winning selection(s) at step 134. In some methods, steps 126 and 130 can be omitted, and one(s) of the primary selection(s) that indicate any one of the dealt cards that has the highest value (even if there are two or more of such cards) can be identified as winning selection(s). Of course, in methods in which players can make primary selections indicative of other combination(s) of the dealt cards, such as a combination of two or more specific ones of the dealt cards, such selections, when correct, can be identified as winning selections.

When gambling is involved, the wager associated with each winning primary selection can be paid to its respective player according to the hand defined by the dealt cards. For methods in which the playing cards include deck(s) of standard playing cards, TABLE 3 provides an exemplary pay table.

TABLE 3
Exemplary Pay Table

| | Poker Hand Type | |
|---|---|---|
| | One Card with the | Two or More Cards with the |
| | Highest Value | Highest Value |
| One Pair | 1:1 | 2:1 |
| Two Pair | 3:1 | 4:1 |
| Three of a Kind | 4:1 | 6:1 |
| Straight | 7:1 | |
| Flush | 11:1 | |
| Full House | 18:1 | 20:1 |
| Four of a Kind | 29:1 | 33:1 |
| Straight Flush | 47:1 | |
| Royal Flush | 76:1 | |
| Five of a Kind | | 127:1 |

As shown, the payout for a given winning primary selection can depend not only on the hand defined by the dealt cards, but also on the number of the dealt cards that each have the highest value. TABLE 3 is provided solely by way of illustration, as other pay tables can include other poker hand(s), poker hands in other pay tables can have payouts that differ from those in TABLE 3, and/or the like. Indeed, any combinations of the playing cards—whether or not poker hands—can be included in a pay table, and such combinations can each be associated with any suitable payout. Further, a pay table can be selected to conform with applicable gaming regulations. The wager(s) associated with primary selection(s) that are not identified as winning selection(s) can be won by the house.

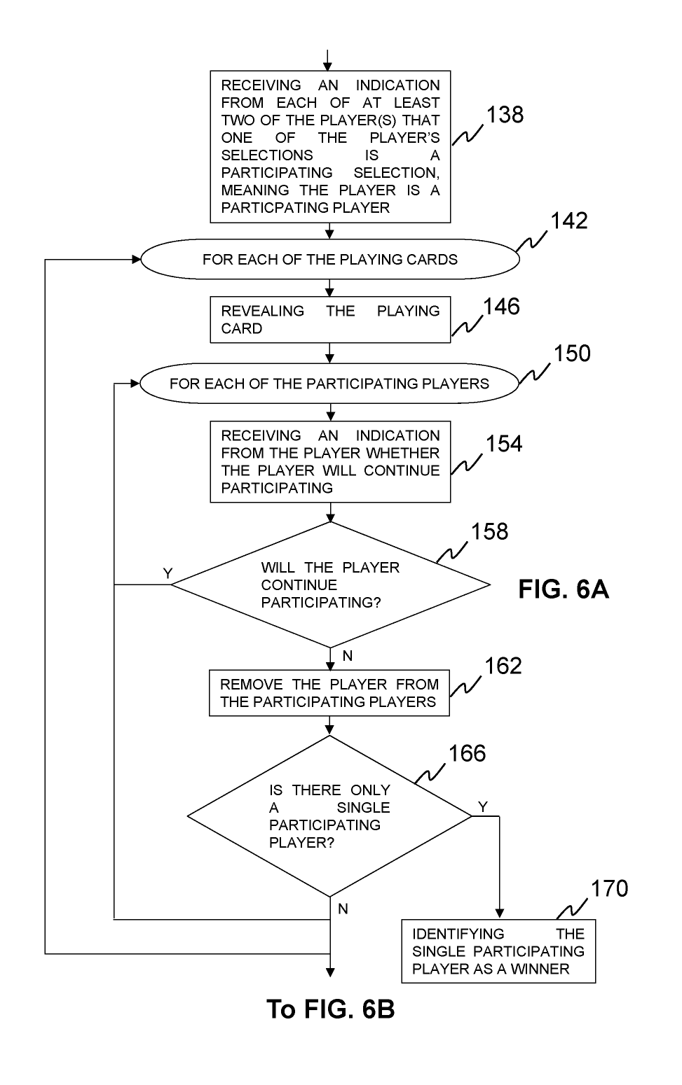

Referring now to FIGS. 6A and 6B, shown is a method that can be used to determine whether each of the secondary selections is a winning selection. Beginning at step 138, indications are received from at least two players that they are participating players. Players can indicate that they are participating by, for example, making a secondary selection (e.g., placing a marker 86 on one of chip positions 58a-58f). When gambling is involved, a wager accompanying a secondary selection can be placed on the side bet position of the playing surface. In some methods, players need not accompany their secondary selections with wagers to indicate that they are participating players.

After receiving indications from at least two players that they are participating players, the cards can be revealed one at a time in a series of rounds at step 142. In each round, at step 146, one card position (e.g., one of 42a-42e) can be identified, and the card occupying that card position can be revealed. At step 150, it can be determined whether each participating player will continue to participate. More particularly, for each participating player, an indication can be received from the player as to whether the player remains a participating player at step 154. The player can indicate continued participation by, for example, placing an additional wager on the side bet position (e.g., raising) or indicating that the player will not place an additional wager (e.g., checking). To indicate that the player will not continue to participate (e.g., the player will fold), the player can, for example, remove their marker from its chip position.

In some methods, if a participating player places an additional wager, the other participating player(s) must place the same additional wager (e.g., match the additional wager) to indicate that they will continue to participate. When, prior to placement of the additional wager, at least one participating player had indicated that they will continue to participate, new indications from those player(s) can be received to, for example, give them an opportunity to match the additional wager or fold. In some methods, when a participating player has placed an additional wager in a round, the other participating player(s) cannot place a wager that is higher than the additional wager during that round.

At step 158, if the player will not continue to participate, the player can be removed from the participating players at step 162. And, at step 166, if there is only a single participating player remaining, that player can be identified as a winning player at step 170. To complete step 150, the above steps can be repeated for each participating player that has not indicated whether they will continue to participate. In processor-implemented methods, players can indicate that they are (and will continue to be) participating players using user-input devices (e.g., 190) associated with those players.

After step 150—and if a player has not been identified as a winning player at step 170—the next round can begin by identifying another card position and revealing the card occupying that card position (step 146 of step 142). The order in which cards are revealed in step 142 can be determined in any suitable fashion. For example, as described above, each of the card positions can be labeled on the playing surface, and such labeling may assign an order to the card positions (e.g., 1-5). In each succeeding round, the card occupying the next card position in the order can be revealed, unless the last-revealed card occupied the final card position in the order, in which instance, the card occupying the first card position in the order can be revealed. For further example, the cards can be revealed, when viewed from the dealer position, from left to right (revealing the left-most card after the right-most card is revealed, if necessary) or from right to left (revealing the right-most card after the left-most card is revealed, if necessary).

While any one of the card positions can be the card position identified in the first round, in some instances, that card position can be identified using a button (e.g., 90) associated with a player (“the button player”). By way of example, when the button player is a participating player and has made a secondary selection corresponding to a single card position, that card position, or—in some methods—the next card position in the order of card positions, can be identified in the first round. On the other hand, if the button player is not a participating player or has made a secondary selection that corresponds to a combination of any two or more of the card positions, the first card position in the order of card positions can be identified in the first round.

In some methods, at step 150, the order in which the participating players indicate whether they will remain participating players can be determined based on the locations of their player positions on the playing surface. For example, once a first participating player has made his or her indication, the participating player occupying the player position nearest to (in a clockwise or counterclockwise direction around the playing surface, depending on the method) the player position of the first participating player can make his or her indication. In some methods, the button player, or the participating player occupying the player position nearest to (as provided above) that of the button player, can be first to give his or her indication.

As shown in FIG. 6B, once all of the cards have been revealed, the highest value of the dealt cards can be determined as well as the number of the dealt cards that each have that value (step 174). If at least two of the dealt cards each have the highest value, at step 178: (1) if one(s) of the secondary selections indicate a combination of any two or more of the dealt cards (e.g., select a first chip position), those secondary selection(s) can be identified as winning selection(s) (step 182); and (2) if none of the secondary selections indicate a combination of any two or more of the dealt cards (e.g., each of the secondary selections selects a second chip position), one(s) of the secondary selections that indicate one of the dealt cards that has the highest value can be identified as winning selection(s) (step 186). On the other hand, if a single one of the dealt cards has the highest value at step 174, one(s) of the secondary selections that indicate that card can be identified as winning selections at step 186. In some methods, if none of the secondary selections are winning selections under the criteria outlined above, at step 186, one(s) of the secondary selections that, of the dealt card(s) indicated by the secondary selections, indicate one having the highest value—even if that card does not have the highest value of all the dealt cards—can be identified as winning selection(s).

When gambling is involved, wagers associated with secondary selections can be paid to participating player(s) that make a winning secondary selection or to a participating player identified as a winning player at step 170. If two or more participating players each make a winning secondary section, those players can be payed equal portions of the wagers.

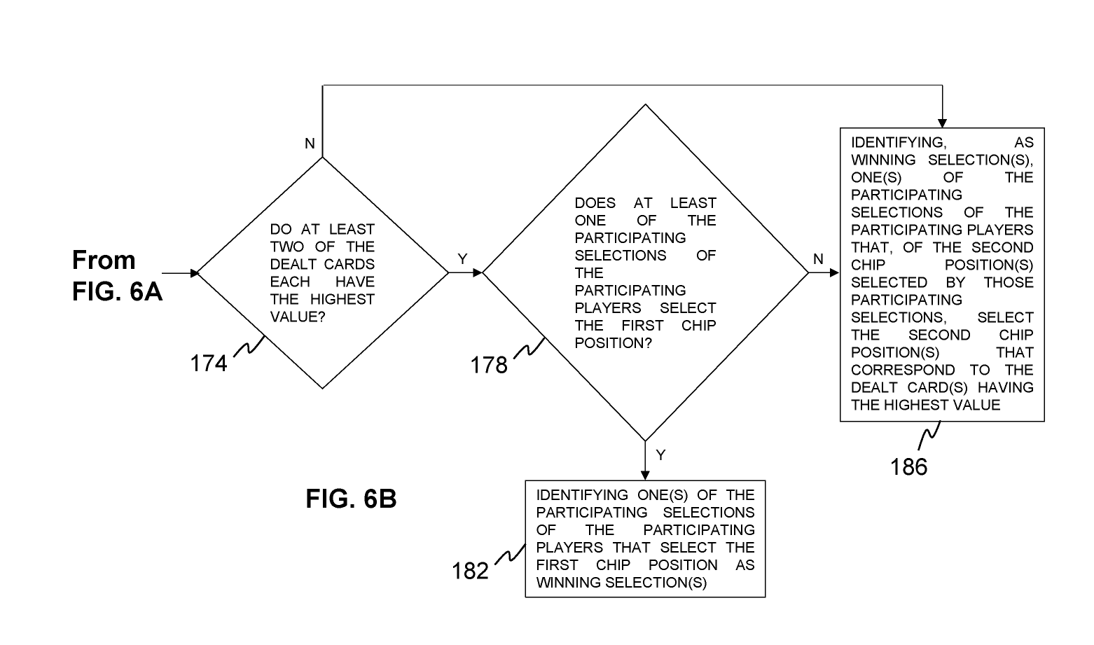

Referring now to FIG. 7, shown is a user-input device 190 for implementing the present methods with one or more processors. User-input device 190 can include a display 194 and a processor 198. Display 194 can be any suitable display, such as, for example, a liquid crystal display, a plasma display, a light-emitting diode display, a cathode ray tube display, and/or the like. In response to commands from processor 198, display 194 can depict one of the present playing surfaces (e.g., 10a) as well as game pieces and cards on that playing surface.

To illustrate, processor 198 can receive inputs from a player (e.g., via buttons, a keyboard, a mouse, and/or the like of user-input device 190), including those indicative of primary selection(s) of the player, a secondary selection of the player, a wager by the player, and/or the like. In some devices, display 194 can be a touchscreen such that, for example, processor 198 can receive such inputs via the display. In response to these inputs, processor 198 can cause display 194 to display game piece(s) on one(s) of the player's chip positions, the side bet position, and/or the like.

User-input device 190 can include memory 202, which can store instructions that, when executed by processor 198, implement one or more steps of the present methods, such as those of FIGS. 4, 5, 6A, and/or 6B.

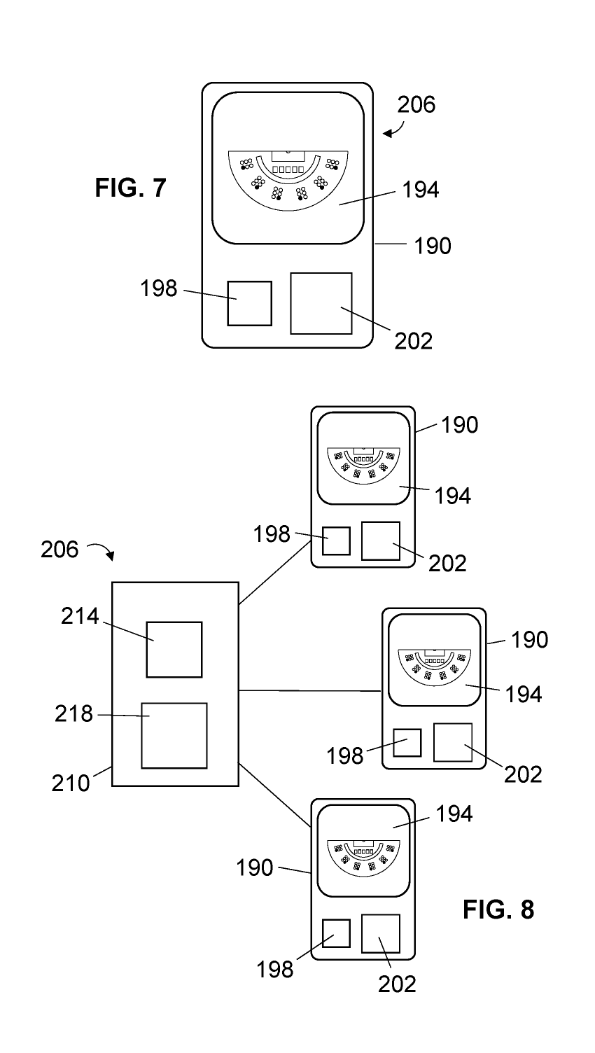

Referring now to FIG. 8, shown is a system 206 for implementing the present methods with one or more processors. System 206 can include one or more user-input devices 190, each having a display 194, a processor 198, and a memory 202. In systems having two or more user-input devices (e.g., 190), a plurality of players can each be associated with a respective one of the user-input devices.

System 206 can comprise a server 210 having a processor 214 and a memory 218. As shown, each user-input device 190 can be in communication with server 210; such communication can be via a wired and/or wireless connection. Similarly to memory 202, memory 218 can store instructions that, when executed by processor 214, implement one or more steps of the present methods, such as those of FIGS. 4, 5, 6A, and/or 6B.

In some instances, processor 214 can implement some steps of the present methods, and processor(s) 198 can implement other steps of the present methods. To illustrate, processor(s) 198 can implement steps 106, 138, and 154 of the methods of FIGS. 4, 5, 6A and 6B, while processor 214 can implement the other steps of those methods. To further illustrate, each processor 198 can receive inputs from a player associated with its user-input device 190, such as those indicative of the player's secondary selection and whether the player will continue to participate, and can communicate those inputs to processor 214. Processor 214, in turn, can communicate with each user-input device 190 to cause its display 194 to show game piece(s) on the playing surface corresponding to those inputs.

In some methods, selection(s) from each of one or more players can be received indicative of which of the dealt cards is expected by the player to have the lowest—rather than the highest—value. Such methods are otherwise similar to the methods described above, except that the lowest value of the dealt cards is used in lieu of the highest value of the dealt cards to determine whether the selection(s) are winning selections.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method for playing a card game with one or more decks of playing cards, the method comprising:
dealing a predetermined number of playing cards, each having a value, onto a dealer position of a playing surface, the playing surface including one or more player positions, each including chip positions demarcated on the playing surface, the chip positions having:
a first chip position corresponding to a combination of two or more of the dealt cards; and
second chip positions, each corresponding to a respective one of the dealt cards; and
receiving, from each of one or more players, each associated with a respective one of the player position(s), one or more primary selections indicative of which of the dealt cards is expected by the player to have the highest value, each of the primary selection(s) including a selection from the group consisting of: the first and second chip positions.

2. The method of claim 1, wherein, for each of the player(s), each of the primary selection(s) is received by receiving one or more chips from the player onto the selected one of the chip positions.

3. The method of claim 1, comprising:
if the dealt cards define a poker hand having a ranking of one pair or higher:
determining the highest value of the dealt cards;
if two or more of the dealt cards each have the highest value, identifying one(s) of the primary selection(s) that select the first chip position as winning primary selection(s); and
if a single one of the dealt cards has the highest value, identifying one(s) of the primary selection(s) that select the second chip position corresponding to the single card as winning primary selection(s); and
if the dealt cards do not define a poker hand having a ranking of one pair or higher, identifying a house as a winner.

4. The method of claim 1, comprising:
determining the highest value of the dealt cards;
if two or more of the dealt cards each have the highest value, identifying one(s) of the primary selection(s) that select the first chip position as winning primary selection(s); and
if a single one of the dealt cards has the highest value, identifying one(s) of the primary selection(s) that select the second chip position corresponding to the single card as winning primary selection(s).

5. The method of claim 4, wherein:
the player(s) comprise two or more players; and
the method comprises receiving, from each of at least two participating ones of the players, a secondary selection indicative of which of the dealt cards is expected by the player to have the highest value, the secondary selection including a selection from the group consisting of: the first and second chip positions.

6. The method of claim 5, wherein, for each of the participating players, the secondary selection is received by:
receiving a marker from the player onto the selected one of the chip positions; and
receiving one or more chips from the player onto a side bet position of the playing surface that is disposed between the dealer position and at least one of the player positions.

7. The method of claim 5, comprising:
determining the highest value of the dealt cards;
if two or more of the dealt cards each have the highest value:
if at least one of the secondary selections selects the first chip position, identifying those secondary selection(s) as winning secondary selection(s); and
if none of the secondary selections select the first chip position, identifying one(s) of the secondary selections that, of the second chip position(s) selected by the secondary selections, select the second chip position(s) that correspond to the dealt card(s) having the highest value as winning secondary selection(s); and
if a single one of the dealt cards has the highest value, identifying one(s) of the secondary selections that, of the second chip position(s) selected by the secondary selections, select the second chip position(s) that correspond to the dealt card(s) having the highest value as winning secondary selection(s).

8. The method of claim 4, wherein:
the dealer position includes card positions demarcated on the playing surface; and
dealing the playing cards is performed such that each of the dealt cards is positioned on a respective one of the card positions.

9. The method of claim 4, wherein the predetermined number of playing cards consists of five playing cards.

10. A system for playing a card game with one or more decks of playing cards, the system including:
a playing surface comprising:
a dealer position having card positions demarcated on the playing surface;
player positions disposed around the dealer position, each of the player positions including chip positions demarcated on the playing surface, the chip positions having:
a first chip position corresponding to a combination of two or more of the card positions; and
second chip positions, each corresponding to a respective one of the card positions.

11. The system of claim 10, wherein:
each of the card positions is labeled on the playing surface with a respective symbol; and
each of the second chip positions is labeled on the playing surface with the same symbol as is its respective one of the card positions.

12. The system of claim 10, wherein the playing surface comprises a side bet position that is:
disposed between the dealer position and at least one of the player positions; and
demarcated on the playing surface.

13. The system of claim 10, comprising:
chips, each configured to be received on one of the chip positions; and
markers, each configured to be received on one of the chip positions.

14. The system of claim 10, wherein the card positions consist of five card positions.

15. A system for playing a card game, the system comprising:
a processor configured to:
cause a display in communication with the processor to depict a playing surface comprising:
a dealer position including a predetermined number of playing cards; and
one or more player positions, each including chip positions demarcated on the playing surface, the chip positions having:
a first chip position corresponding to a combination of two or more of the predetermined number of playing cards; and
second chip positions, each corresponding to a respective one of the predetermined number of playing cards; and
receive, from each of one or more players, each associated with a respective one of the player position(s), one or more primary selections indicative of which of the predetermined number of playing cards is expected by the player to have the highest value, each of the primary selection(s) including a selection from the group consisting of: the first and second chip positions.

16. The system of claim 15, wherein the processor is configured to:
if the predetermined number of playing cards define a poker hand having a ranking of one pair or higher:
determine the highest value of the predetermined number of playing cards;
if two or more of the predetermined number of playing cards each have the highest value, identify one(s) of the primary selection(s) that select the first chip position as winning primary selection(s); and
if a single one of the predetermined number of playing cards has the highest value, identify one(s) of the primary selection(s) that select the second chip position corresponding to the single card as winning primary selection(s); and
if the predetermined number of playing cards do not define a poker hand having a ranking of one pair or higher, identify a house as a winner.

17. The system of claim 15, wherein the processor is configured to:
determine the highest value of the predetermined number of playing cards;
if two or more of the predetermined number of playing cards each have the highest value, identify one(s) of the primary selection(s) that select the first chip position as winning primary selection(s); and
if a single one of the predetermined number of playing cards has the highest value, identify one(s) of the primary selection(s) that select the second chip position corresponding to the single card as winning primary selection(s).

18. The system of claim 17, wherein the processor is configured to receive, from each of at least two participating ones of the player(s), a secondary selection indicative of which of the predetermined number of playing cards is expected by the player to have the highest value, the secondary selection including a selection from the group consisting of: the first and second chip positions.

19. The system of claim 18, wherein the processor is configured to:
determine the highest value of the predetermined number of playing cards;
if two or more of the predetermined number of playing cards each have the highest value:
if at least one of the secondary selections selects the first chip position, identify those secondary selection(s) as winning secondary selection(s); and
if none of the secondary selections select the first chip position, identify one(s) of the secondary selections that, of the second chip position(s) selected by the secondary selections, select the second chip position(s) that correspond to the predetermined number of playing card(s) having the highest value as winning secondary selection(s); and
if a single one of the predetermined number of playing cards has the highest value, identify one(s) of the secondary selections that, of the second chip position(s) selected by the secondary selections, select the second chip position(s) that correspond to the predetermined number of playing card(s) having the highest value as winning secondary selection(s).

20. The system of claim 17, wherein the predetermined number of playing cards consists of five playing cards.
